(19) United States
(12) Patent Application Publication
(10) Pub. No.: US 2007/0273123 A1
(43) Pub. Date: Nov. 29, 2007

(54) Trailer step

(76) Inventor: Allen Wilson, Dexter, MO (US)

Correspondence Address: Entrepreneurial Studies and Development, CMSU, Dockery Suite 102, Warrensburg, MO, 64093, US

(21) Appl. No.: 11/440,979

(22) Filed: May 25, 2006

(51) Int. Cl. B60R 3/00

(52) U.S. Cl. 280/166

(57) ABSTRACT

Stairway for use on a semi tractor trailer or similar trailer. The stairway includes stairs mounted on an outer pipe and the outer pipe is rotatably mounted over an inner pipe. The inner pipe is pinned to a trailer bed in a stake pocket. The outer pipe can be rotated between a first position where the steps are deployed for use and a second position where the steps are locked under the bed of the trailer.

### RELATED APPLICATIONS

None

### BACKGROUND OF THE INVENTION

In the trucking industry it is common practice to pull a trailer. A common problem is for the truck driver to need to climb up on the trailer. Climbing onto the trailer presents a problem for many truck drivers as larger trailers can be quite tall. Not infrequently truckers are injured either attempting to climb onto the trailer or in jumping off the trailer.

U.S. Pat. No. 5,024,292 discloses one prior art trailer ladder. This patent discloses a ladder 10 that can be positioned within a rail space 22 between a trailer bed and a rail. The ladder disclosed can be removed from the trailer when not in use or alternately the bottom section of the ladder can be folded up so that it will not strike objects on the ground if the trailer is moving. Such a ladder can be left in place while the truck is on the road. The ladder of U.S. Pat. No. 5,024,292 is somewhat complex requiring a spring and two positioning devices on the rail. Removal of the ladder from the trailer is undesirable due to the limited space to store things on a truck and due to the fact that once removed it is a hassle to put back and the trucker will tend to not use it at all. Also even when the ladder lower section is retracted the remainder of the ladder remains even with the edge of the rail creating somewhat of a road hazard. While easier than no ladder, this ladder also creates a climbing challenge in that the foot and hand holds (28) are under the rail 16, presenting a nearly vertical climb with the rail in the way of actually getting on the trailer. This arrangement requires dexterity to get up and over the rail while the truckers body hangs awkwardly out of balance.

Another problem with U.S. Pat. No. 5,024,292 is in climbing off the trailer the steps 28 are not visible as they are under the edge of the trailer. This is a problem in the dark, when there may be water or even ice on the trailer. The trucker is climbing down often adjacent a busy roadway and having the stairs out of the trucker sight makes a dangerous fall more likely.

Thus it can be seen that there is a need for a ladder that provides easy access to a trailer bed and that can remain in place safely even when the truck and trailer are in motion. There is a need for a ladder that is quick, easy and safe to use both in climbing up and down the trailer.

### SUMMARY OF THE INVENTION

The present invention provides a stairway that pivots from a first position under the trailer to a second position out from under the trailer. The treads of the stairway are staggered such that the bottom stair is further outward from the truck than the top most stair when the stairway is in its second position. This yields a stairway that is easy to climb. It also gives a stairway with a set of stairs that are all visible to a trucker about to walk down them.

### BRIEF DESCRIPTION OF THE DRAWINGS

FIG. 1 shows a view of the trailer with the stairway attached in its first position;

FIG. 2 shows the stairway in a second position;

FIG. 3 shows details of the device in use; and

FIG. 4 shows an exploded view of the device.

### DETAILED DESCRIPTION OF THE DEVICE

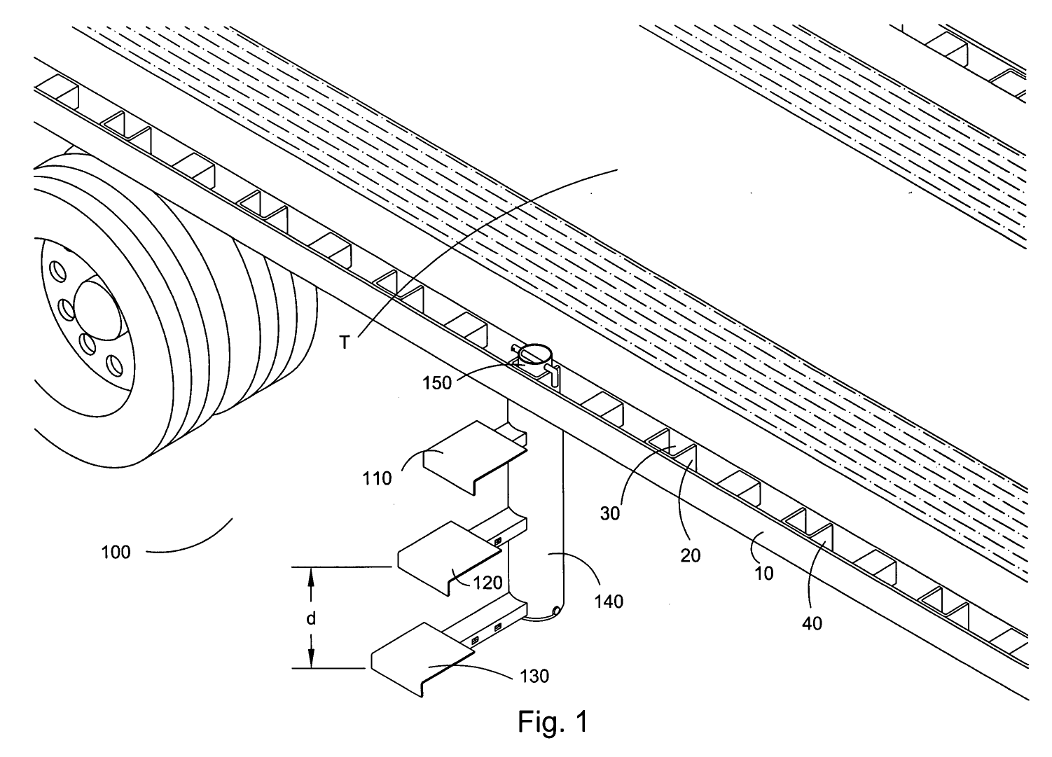

FIG. 1 shows a trailer T with a side rail 10 supported by a plurality of stake pockets 20, each stake pocket 20 defining an opening 30 between the walls 40 of the stake pocket 20. FIG. 1 shows a stairway 100 including a plurality of steps 110, 120 and 130. The stairway 100 is shown mounted on the trailer T and hanging from one of the stake pockets 40. The stairway 100 includes a tubular section such as outer pipe section 140 rotatably mounted on an inner pipe section 150. The stairway is shown in a first position with the steps 110, 120, 130 deployed for use adjacent said trailer.

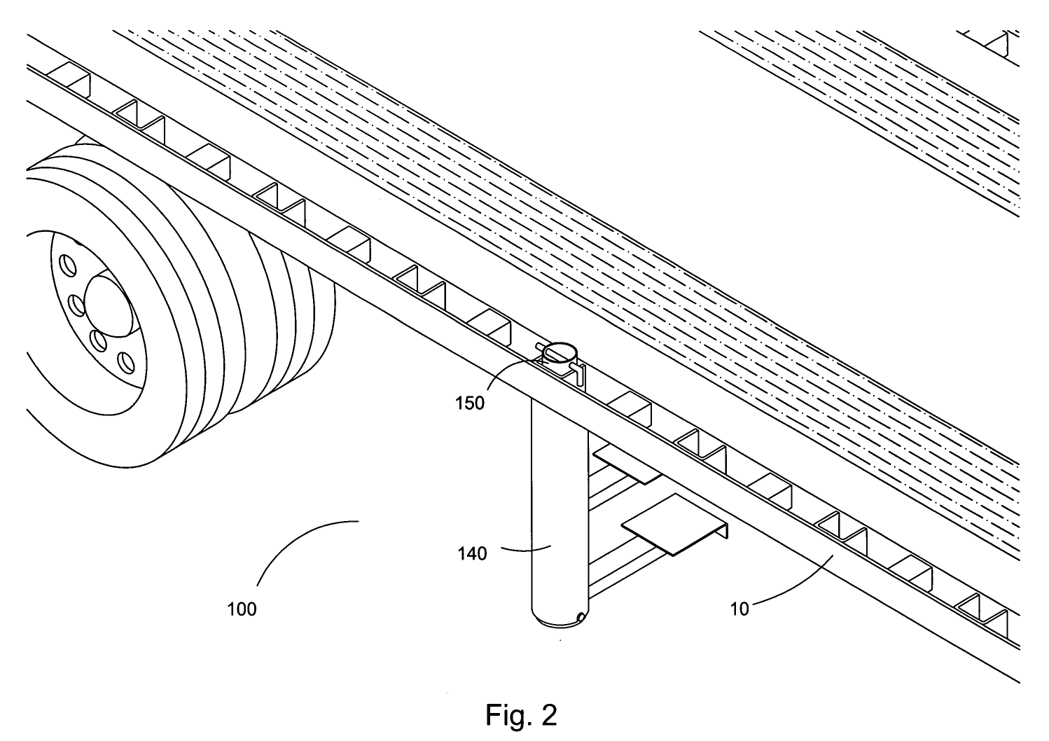

FIG. 2 shows the stairway 100 rotated 180 degrees such that the steps 110, 120 and 130 are under the bed of the trailer. In this second position, the steps 110, 120, 130 are well out of the way of traffic such that the truck (not shown) and trailer can be safely driven in traffic. The bottoms of the pipes 140 and 150 are above the ground enough to provide safe clearance.

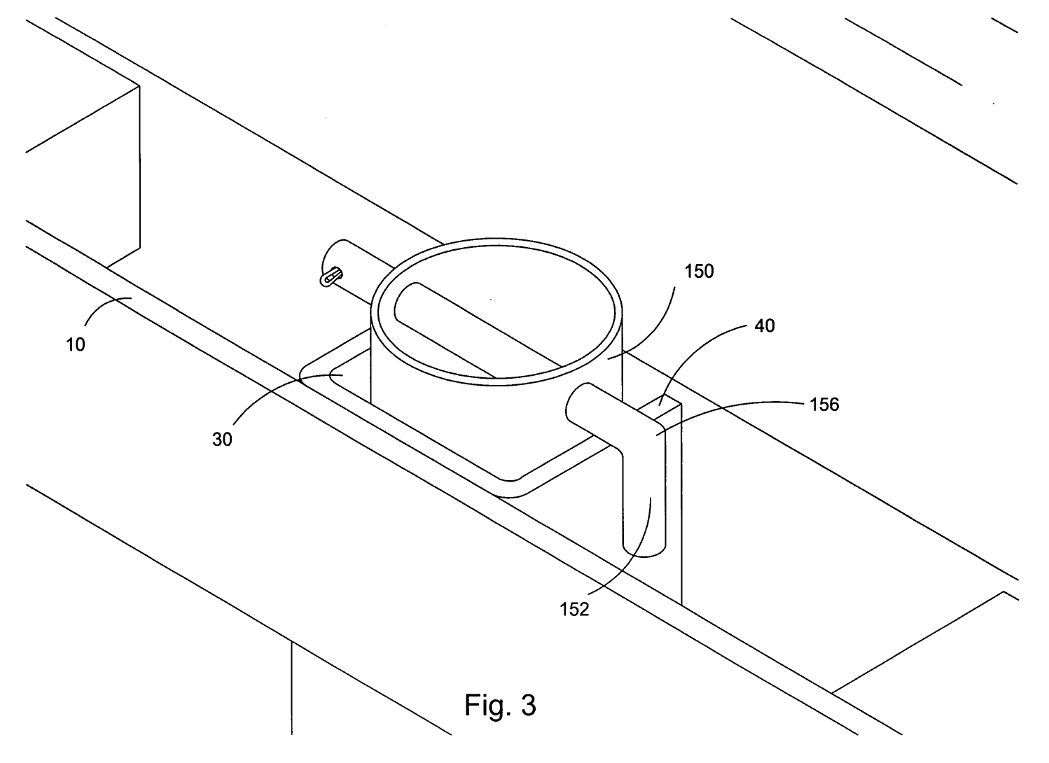

FIG. 3 shows details of the stairway 100 mounted in a stake pocket opening 30. An upper portion of pipe section 150 protrudes above the top of the wall 40 and a pin 152 passes through holes in the top of the pipe section 150 such that the pipe section 150 is held in place. The outer diameter of the pipe section 150 fits snuggly within the stake pocket opening 30 such that the pipe section 150 has little or no room to move within the pocket opening 30. The pin 152 rests on the top of stake pocket walls 40. The pin 152 can include a bend 156 and can be held in place by a retainer such as cotter key 158.

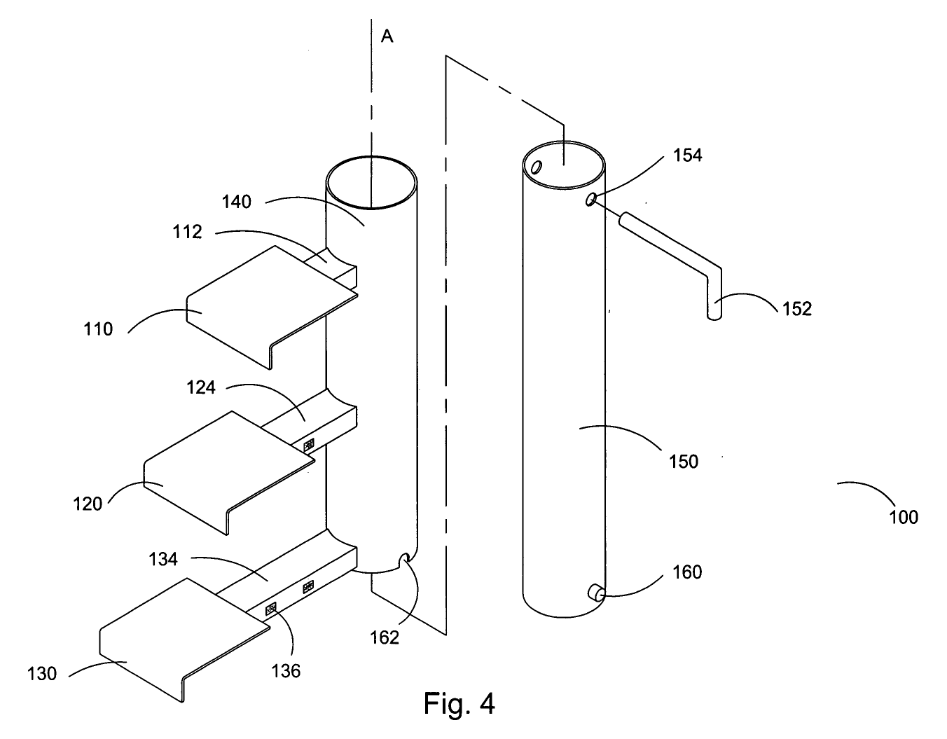

FIG. 4 shows an exploded view of the stairway 100. The outer pipe section 140 is sized to fit snuggly over inner pipe section 150. Steps 110, 120 and 130 are attached to the outer pipe 140 by welding for example. Each step 110, 120, 130 includes a bracket. Step 110, the top step includes the shortest bracket 112. Step 120 includes the bracket 124 that is longer than bracket 112 but shorter than bracket 134 and the bottom step 130 includes the longest bracket 134. Thus as a user climbs the stairs from the bottom 130 to the top step 110 they get closer to the inner pipe axis A and closer to the bed of the truck. As a user climbs the steps from the bottoms step 130 toward the top step 110 the next natural step is to step onto the bed of the trailer T. That is to say that the bed of the trailer forms a fourth natural step equally spaced out with the other three. FIG. 1 shows that there is a vertical distance ‘d’ between each step, that distance ‘d’ is the same from the top step 110 onto the bed of the trailer.

FIG. 4 shows that there can be reflectors 136 on each step 110, 120, 130. The reflectors make the stairway 100 more visible to oncoming traffic. In FIGS. 2 and 4 it can be seen that when the inner pipe 150 is placed within the outer pipe 140 that the outer pipe 140 has a notch 162 that can come to rest on the bar 160. Though not shown, there could be a second notch 162 180 degree away and also on the bottom of outer pipe section 140. The notch 162 fits over the bar 160 and locks it into either the first position shown in FIG. 1 or the second position shown in FIG. 2. Once the stairway 100 is pivoted to the first or second position its weight tends to hold it in that position until a user lifts the outer pipe 140 and rotates it to the other position.

In use, and starting with the stairway 100 disassembled, the inner pipe 150 can be placed into the outer pipe 140 with the notch 162 resting on the bar 160. The inner and outer pipe sections 140, 150 are then lifted until the top end of inner pipe 150, which is longer than outer pipe 140, protrudes through the top of a trailer stake pocket opening 30 as shown in FIG. 3. Then a pin 152 is slipped through holes 154 in the top of inner pipe 150. Then the stairway 100 is in place for use. A user can lift the outer pipe 140 and rotate it to either the first position for access to the trailer shown in FIG. 1 or the second position shown in FIG. 2 for storage. Note that as a user steps up the steps from bottom step toward the trailer, step 130 is separated from step 120 by a distance ‘d’. Step 120 is separated from step 110 by the same distance ‘d’ and the top surface of the trailer is also separated from the top step 110 by the distance ‘d’ such that a user can take 4 approximately equal steps to access the bed of the trailer from the ground. The user can rotate the outer pipe section 140 to the position shown in FIG. 2 for storage. It is also possible to pull the pin 152 and remove the entire stairway 100 from the trailer T though this is normally not required.

Though shown in use with a trailer it will be understood that the stairway 100 could be used with any vehicle such as a flat bed truck having a stack pocket 30.

1. A stairway for use with a trailer having a top surface and a stake pocket, the stairway comprising;
an inner pipe section,
an outer pipe section rotatably mounted over the inner pipe,
at least one step attached to an outer surface of said outer pipe section,
said inner pipe mountable to a trailer stake pocket such that said outer pipe can be rotated to a first position where said steps are accessibly deployed adjacent said trailer to be climbed and a second position where said steps are under said trailer top surface.

2. The stairway of claim 1 including a second step attached to said outer pipe section, a distance above said first step wherein said first step is attached to said outer pipe section by a first bracket and said second step attached to said outer pipe section by a second bracket, said first bracket being longer than said second bracket.

3. The stairway of claim 2 including a third step attached to said outer pipe section.

4. The stairway of claim 2 including a hole passing through a first end of said inner pipe and including a pin sized to fit within said hole to support said inner pipe in said stake pocket.

5. The stairway of claim 2 including a lock to lock said outer pipe in said first position and in said second position.

6. The stairway of claim 5 wherein said lock includes a bar on said inner pipe and a notch on said outer pipe.

7. A stairway for use with a trailer having a stake pocket, the stairway comprising;
an inner tubular section,
an outer tubular section rotatably mounted over the inner tubular section,
at least one step attached to an outer surface of said outer tubular section,
said inner tubular section mountable to a trailer stake pocket such that said outer tubular section can be rotated to a first position where said steps are accessibly deployed adjacent said trailer to be climbed and a second position where said steps are under said trailer.

8. The stairway of claim 7 including a second step attached to said outer tubular section, a distance above said first step wherein said first step is attached to said outer tubular section by a first bracket and said second step attached to said outer tubular section by a second bracket, said first bracket being longer than said second bracket.

9. The stairway of claim 8 wherein said inner and outer tubular sections include a common axis and wherein said first step is below said second step and said first step is farther from said axis than said second step.

10. The stairway of claim 9 including a third step attached to said outer tubular section and closer to said axis than said second step.

11. The stairway of claim 8 including a lock to lock said outer pipe in said first position and in said second position.

12. The stairway of claim 8 wherein said inner tubular section rotates 180 degrees from said first position to said second position and locks in said first and second positions.

13. A stairway for use with a vehicle having a stake pocket, the stairway comprising;
an inner tubular section,
an outer tubular section rotatably mounted over the inner tubular section,
at least one step attached to said outer tubular section,
said inner tubular section mountable to a the stake pocket such that said outer tubular section can be rotated to a first position where said steps are deployed adjacent said vehicle to be climbed and a second position where said steps are under said vehicle.

14. The stairway of claim 13 including a second step attached to said outer tubular section, a distance above said first step wherein said outer tubular section has a central axis and said first step is attached to said outer tubular section closer to said axis than said second step.

15. The stairway of claim 13 including a third step attached to said outer tubular section and wherein said third step is attached closer to said axis than said second step.

16. The stairway of claim 15 including a lock to lock said outer tubular section in said first position and in said second position wherein said lock includes a bar on an end of said inner tubular section and a cooperating notch on said outer tubular section such that gravity holds said outer tubular section notch engaged with said bar on said inner tubular section.

17. The stairway of claim 16 wherein said inner tubular section rotates 180 degrees from said first position to said second position and locks in said first and second positions.

18. The stairway of claim 16 wherein said outer pipe must be lifted to rotate from said first position to said second position.
